(19) United States
(12) Patent Application Publication
(10) Pub. No.: US 2002/0075489 A1
(43) Pub. Date: Jun. 20, 2002

(54) Correct order output

(76) Inventor: Michelle E. Evans, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/746,659

(22) Filed: Dec. 19, 2000

(51) Int. Cl. G06F 15/00; B41J 1/00

(52) U.S. Cl. 358/1.6; 358/1.15

(57) ABSTRACT

An output accumulation sequence of a destination of the print job is discovered and if the output accumulation sequence of the destination is back of second sheet to front of first sheet, the sheets of the print job are sequenced in reverse order. The output accumulation sequence of the destination is discovered either by choosing the output accumulation sequence or ascertaining the destination and discovering, from the destination, the output accumulation sequence of the destination. The output accumulation sequence of the destination is discovered from the destination by either querying the destination or searching an index for a record of the destination and discovering the output accumulation sequence from the record of the destination.

### FIELD OF THE INVENTION

This invention relates in general to printer technology and, more particularly, to outputting sheets in a desirable order.

### BACKGROUND OF THE INVENTION

It is well known that the output accumulation sequence varies among output destinations. An output destination is either a printer or an output tray, or bin, of a printer. It is usually desirable that printed sheets be accumulated with the front of the second sheet to the back of the first sheet. Sheets printed in this order do not require manual resequencing. However, some output destinations accumulate printed sheets with the back of the second sheet to the front of the first sheet.

Output accumulation with the back of the second sheet to the front of the first sheet is particularly troublesome when the printed sheets are bound together in the output device after all of the sheets of a print job are printed. Some output trays for printers have a stapling function or other binding mechanism, such as glue, that binds the sheets together after all of the sheets of the print job are printed. Further adding to the complexity of the problem are booklet makers that print multiple pages on each sheet and then bind the sheets together after all of the sheets of the print job are printed.

One prior solution for outputting sheets in a correct order has been to provide a user with an option to print the pages of the print job in a reverse order. One problem with this solution is that the user may forget to select the option to print the pages in reverse order. A second problem with this solution is that a user may not know what the output accumulation sequence is for the intended destination. A third problem with this solution is that printing pages in reverse order to a booklet maker results in out of sequence pages that are not manually correctable.

### SUMMARY OF THE INVENTION

According to principles of the present invention, an output accumulation sequence of a destination of the print job is discovered and if the output accumulation sequence of the destination is back of second sheet to front of first sheet, the sheets of the print job are sequenced in reverse order.

According to further principles of the present invention, the output accumulation sequence of the destination is discovered either by choosing the output accumulation sequence or ascertaining the destination and discovering, from the destination, the output accumulation sequence of the destination.

According to further principles of the present invention, the output accumulation sequence of the destination is discovered from the destination by either querying the destination or searching an index for a record of the destination and discovering the output accumulation sequence from the record of the destination.

### DESCRIPTION OF THE DRAWINGS

FIG. 1 is a block diagram representing one embodiment of the present invention system for sequencing sheets of a print job.

FIGS. 2 through 5 represent two sheets of output from a booklet maker.

FIG. 6 is a flow chart illustrating one embodiment of the present invention method for sequencing sheets of a print job.

### DETAILED DESCRIPTION OF THE INVENTION

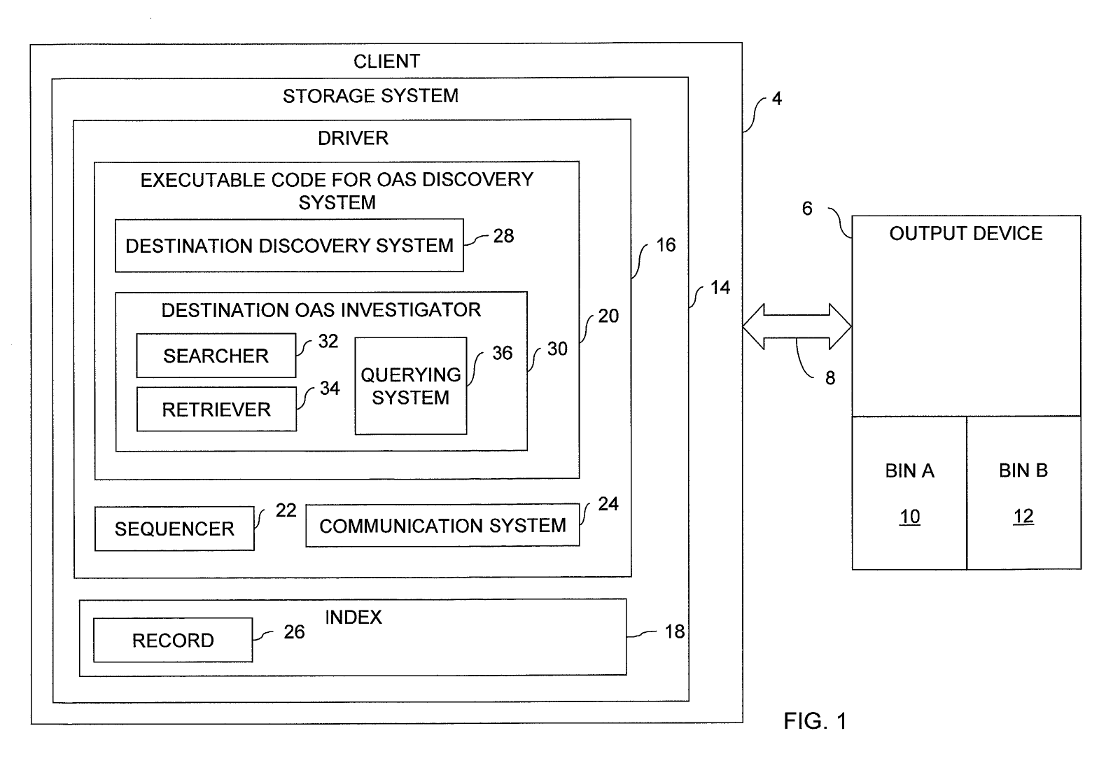

Illustrated in FIG. 1 is a system 2 for sequencing and outputting sheets of a print job. System 2 includes a client 4, at least one output device 6, and a communication path 8 between client 4 and output device 6.

Communication path 8 is any path for providing communication between client 4 and output device 6. Examples of communication path 8 include a local connection and a network, such as an intranet or the Internet.

Output device 6 is any device that produces output onto sheets of print media. Examples of output device 6 include a printer, a mopier, and a copier. Output device 6 includes at least one output bin 10,12. For purposes of this discussion, an output tray is one example of an output bin. Each bin 10,12 has a specific output accumulation sequence (OAS). For example, bin A 10 may have an OAS where the back of a second printed sheet is positioned against the font of a first printed sheet. For clarity, this OAS will be referred to as a back of second sheet to front of first sheet OAS. Continuing the example, bin B 12 may have an OAS where the front of the second printed sheet is positioned against the back of the first printed sheet. For clarity, this OAS will be referred to as a front of second sheet to back of first sheet OAS.

In another example, bin A 10 is a booklet maker with a back of second sheet to front of first sheet OAS. Output device 6 prints multiple pages of a print job onto each sheet of media and feeds the sheets to booklet maker 10.

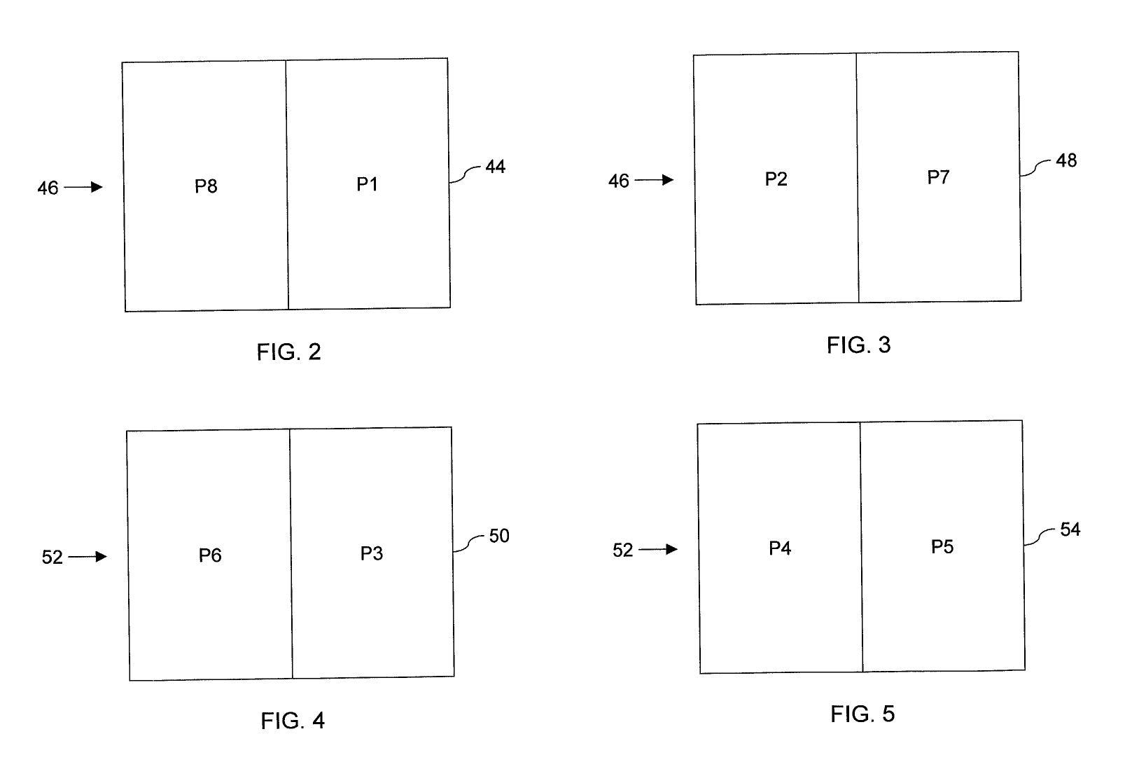

FIGS. 2-5 illustrate one example of the sheets of a print job having eight pages printed on two sheets. For some printers, the configuration of the pages on the sheets is different than illustrated in FIGS. 2-5.

FIG. 2 shows the front 44 of first sheet 46. Pages 1 and 8 are printed on front 44 of first sheet 46. FIG. 3 shows the back 48 of first sheet 46. Pages 2 and 7 are printed on back 48 of first sheet 46. FIG. 4 shows the front 50 of a second sheet 52. Pages 6 and 3 are printed on front 50 of second sheet 52. FIG. 5 shows the back 54 of second sheet 52. Pages 4 and 5 are printed on back 54 of second sheet 52. Once printed first sheet 46 on second sheet 52 are folded together and fastened. If allowed to accumulate in back 54 of second sheet 52 to front 44 of first sheet 46 order, the pages, when bound, will be in the order p3, p4, p1, p2, p7, p8, p5, p6. If printed and accumulated in the correct order, the pages will be in the correct sequence, namely p1-p8.

Client 4 is any device or system, such as a specific or general purpose computer, that includes a means, such as a processor, for processing executable code. Client 4 includes a storage system 14.

Storage system 14 is any system for storing data or executable code. Storage system 14 may include one or more storage devices. Storage system 14 may also include a program storage device tangibly embodying a program, applet, or instructions executable by client 4 for performing the method steps of the present invention executable by client 4. Storage system 14 is any type of storage media such as magnetic, optical, or electronic storage media. Although depicted within client 4, storage system 14 may, alternatively, be external to client 4. Stored within storage device 14 is driver 1 6 and, in one embodiment, index 18.

Index 18 is any type of index, such as a list or table, for storing at least one record 26. Record 26 includes information about the OAS for destinations. Examples of destinations include output device 6, bin A 10, and bin B 12.

Driver 16 is an instruction set or executable code for creating a print job in a format executable by output device 6. Driver 16 may be embodied in a program, applet, or instructions executable by client 4. Driver 16 includes, in at least one embodiment, executable code 20 for an output discovery system, a sequencer 22, and a communication system 24. In alternative embodiments, executable code 20 for an output discovery system, sequencer 22, and communication system 24 reside outside of driver 16. Sequencer 22 and communication system 24 are each instruction sets or portions of executable code.

Executable code 20 for an output discovery system includes a destination discovery system 28 and a destination discovery investigator 30. Destination discovery system 28 is any instruction set or executable code for ascertaining the destination of the print job. The specific embodiment of destination discovery system 28 depends upon the method by which the destination of the print job will be determined.

Destination discovery investigator 30 is any instruction set or executable code for discovering, from the destination, the OAS of the destination. The specific embodiment of destination discovery investigator 30 depends upon the method by which the OAS of the destination will be discovered. Destination discovery investigator 30 includes, in one embodiment, a searcher 32 and a retriever 34.

Searcher 32 is any instruction set or executable code for searching index 18 for record 26 of a destination. Retriever 34 is any instruction set or executable code for discovering the OAS of the destination from record 26.

In an alternative embodiment, destination discovery investigator 30 includes a querying system 36. Querying system 36 is any instruction set or executable code for querying a destination for the OAS of the destination.

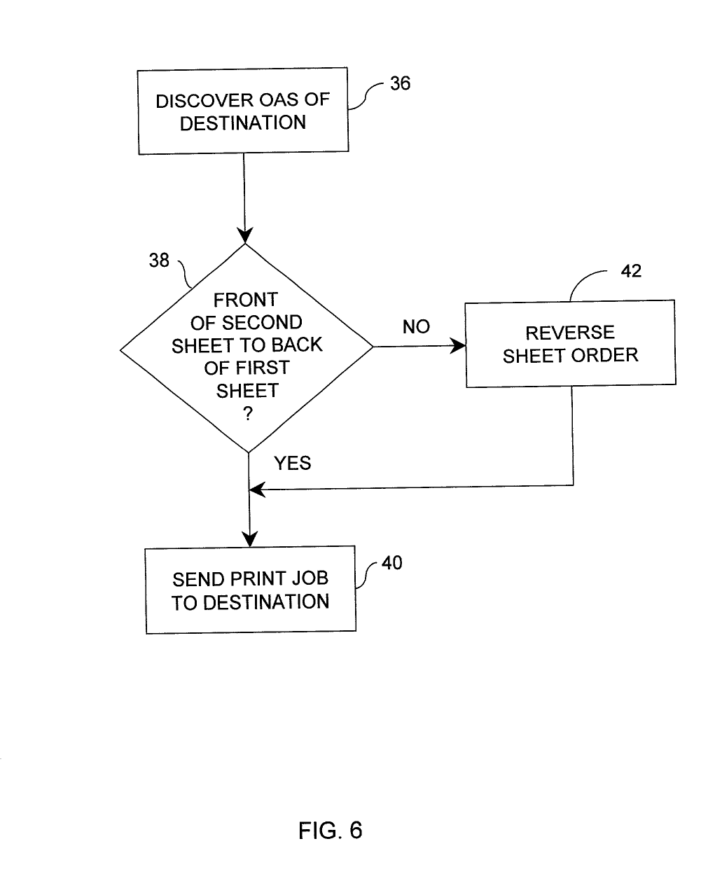

FIG. 6 is a flow chart representing the steps of one embodiment of the present invention. Although the steps represented in FIG. 6 are presented in a specific order, the present invention encompasses variations in the order of steps. Furthermore, additional steps may be executed between the steps illustrated in FIG. 6 without departing from the scope of the present invention.

The OAS of the destination is discovered 36. In one embodiment, the OAS of the destination is discovered 36 by choosing the OAS of the destination.

In an alternate embodiment, the OAS of the destination is discovered 36 by ascertaining the destination of a print job and discovering 36, from the destination, the OAS of the destination. In one embodiment, discovering 36 the OAS of the destination from the destination includes searching index 18 for record 26 of the destination and discovering the OAS from record 26 of the destination. In an alternate embodiment discovering 36, from the destination, the OAS of the destination includes querying the destination for the OAS of the destination.

If 38 the OAS of the destination is front of second sheet to back of first sheet, the print job is processed normally and sent 40 to the destination. If 38 the OAS is instead back of second sheet to front of first sheet, the sheets of the print job are sequenced 42 in reverse order. Sequencing 42 the sheets in reverse order is accomplished either by creating the print job with sheets in reversed order or acting upon an existing print job to reverse the order of the sheets. Once the sequence of the sheets has been reversed 42, the print job is sent 40 to the destination.

The foregoing description is only illustrative of the invention. Various alternatives and modifications can be devised by those skilled in the art without departing from the invention. Accordingly, the present invention embraces all such alternatives, modifications, and variances that fall within the scope of the appended claims.

What is claimed is:

1. A method for sequencing sheets of a print job having multiple sheets, the method comprising:
(a) discovering an output accumulation sequence (OAS) of a destination of the print job; and,
(b) responsive to a back of second sheet to front of first sheet OAS of the destination, sequencing the sheets of the print job in reverse order.

2. The method of claim 1 wherein discovering the OAS of the destination includes:
(a) ascertaining the destination of the print job; and,
(b) discovering, from the destination, the OAS of the destination.

3. The method of claim 2 wherein discovering, from the destination, the OAS of the destination includes:
(a) searching an index for a record of the destination; and,
(b) discovering the OAS from the record of the destination.

4. The method of claim 2 wherein discovering, from the destination, the OAS of the destination includes querying the destination for the OAS of the destination.

5. The method of claim 1 wherein discovering the OAS of the destination includes choosing the OAS of the destination.

6. The method of claim 1 further including sending the reverse sequenced print job to the destination.

7. A system for sequencing sheets of a print job having multiple sheets, the system comprising:
(a) an output accumulation sequence (OAS) discovery system configured to discover an OAS of a destination of the print job; and,
(b) a sequencer configured to respond to a back of second sheet to front of first sheet OAS of the destination, by sequencing the sheets of the print job in reverse order.

8. The system of claim 7 wherein the OAS discovery system includes:
(a) a destination discovery system configured to ascertain the destination of the print job; and,
(b) a destination OAS investigator configured to discover, from the destination, the OAS of the destination.

9. The system of claim 8 wherein the destination OAS investigator includes:
(a) an index having a record of the destination, the record including the OAS of the destination;
(b) a searcher configured to search the index for the record of the destination; and,
(c) a retriever configured to discover the OAS from the record of the destination.

10. The system of claim 8 wherein the destination OAS investigator includes a querying system configured to query the destination for the OAS of the destination.

11. The system of claim 7 wherein the OAS discovery system includes a chooser configured to choose the OAS of the destination.

12. The system of claim 7 further including a communication system configured to send reverse sequenced print jobs to the destination.

13. A program storage device readable by a computer, tangibly embodying a program, applet, or instructions executable by the computer to perform method steps for sequencing sheets of a print job having multiple sheets, the method steps comprising:
(a) discovering an output accumulation sequence (OAS) of a destination of the print job; and,
(b) responsive to a back of second sheet to front of first sheet OAS of the destination, sequencing the sheets of the print job in reverse order.

14. The program storage device of claim 13 wherein the method step of discovering an OAS of the destination includes:
(a) ascertaining the destination of the print job; and,
(b) discovering, from the destination, the OAS of the destination.

15. The program storage device of claim 14 wherein the method step of discovering, from the destination, the OAS of the destination includes:
(a) searching an index for a record of the destination; and,
(b) discovering the OAS from the record of the destination.

16. The program storage device of claim 14 wherein the method step of discovering, from the destination, the OAS of the destination includes querying the destination for the OAS of the destination.

17. The program storage device of claim 1 3 wherein the method step of discovering an OAS of the destination includes choosing the OAS of the destination.

18. The program storage device of claim 13 wherein the method steps further include sending the reverse sequenced print job to the destination.
